(19) United States
(12) Patent Application Publication
(10) Pub. No.: US 2017/0148185 A1
(43) Pub. Date: May 25, 2017

(54) METHODS OF SAMPLING PIXELS OF IMAGE AND DETERMINING SIZE OF AN AREA OF IMAGE

(71) Applicants: NATIONAL TAIPEI UNIVERSITY OF TECHNOLOGY, TAIPEI (TW); TAIPEI MEDICAL UNIVERSITY, TAIPEI (TW)

(72) Inventors: Chao-Cheng WU, Taipei (TW); Jiann-Her LIN, Taipei City (TW); Yung-Hsiao CHIANG, Taipei City (TW)

(21) Appl. No.: 14/952,606

(22) Filed: Nov. 25, 2015

(51) Int. Cl. G06T 7/60; G06K 9/62; G06T 7/00

(52) U.S. Cl. CPC G06T 7/602; G06T 7/0012; G06K 9/6262; G06K 9/6269; G06T 2207/10088; G06T 2207/20081; G06T 2207/30012

(57) ABSTRACT

The present disclosure relates to a method of sampling pixels of an image. The method includes: determining a target area on the image; and sampling pixels from the target area, comprising: sorting background pixels based on a first spectral feature and divide them into a first number of groups; sorting target pixels based on a second spectral feature and divide them into a second number of groups; sampling background pixels from each of the first number of groups; and sampling target pixels from each of the second number of groups.

### BACKGROUND

The spinal canal (or vertebral canal or spinal cavity) is the space in the vertebral column formed by the vertebrae through which the spinal cord passes. It is a process of the dorsal body cavity. This canal is enclosed within the vertebral foramen of the vertebrae. In the inter-vertebral spaces, the canal is protected by the ligamentum flavum posteriorly and the posterior longitudinal ligament anteriorly.

Spinal stenosis is a narrowing of the canal which can occur in any region of the spine and can be caused by a number of factors. For example, in lumbar region of spine, the spine canal, which is formed by the aligned vertebral foramina of the five lumbar vertebrae, may contain spinal cord and lumbar spinal nerve roots enclosed by dura sac and cerebrospinal fluid (CSF). Lumbar spinal stenosis (LSS) occurs whenever any of the structures surrounding the spinal canal is affected by disease or degeneration that results in enlargement of the structure into the space of the canal, which causes progressive narrowing of the spinal canal. The symptoms have a great impact on the essential content within the spinal canal. In the absence of prior surgery, the spinal canal may become narrowed and the decompression of the lumbar spinal stenosis is the main goal of many surgical interventions. It is estimated that approximately 250,000-500,000 people in the United States suffer from spinal stenosis, which means that about 1 of 1000 persons whose age is greater than 65 years and about 5 of 1000 persons whose age is greater than 50 years are diagnosed with spinal stenosis.

Lumbar spinal stenosis (LSS) is the leading preoperative diagnosis for adults older than 65 years who undergo spine surgery. Radiological examination is one of manners for the diagnosis of LSS, and MRI is an imaging modality due to its soft-tissue contrast. The current diagnoses were mostly based on semiquantitative and qualitative radiologic criteria, however, merely a few quantitative criteria were available. The qualitative criteria were based on experience of the clinics, which could be considered as subjective and non-reproducible diagnosis. Seminquantitative criteria normally introduce levels for labeling the severity of spinal stenosis to hopefully reduce the disadvantages of the qualitative criteria. The quantitative criteria could provide more objective and robust results, which is also easier for long term tracking. However, the disadvantage of the quantitative methods is the requirement of a lot of time and effort to conduct since the region of interest has to be circled and defined manually by experienced clinics or physicians, which adversely prevents the quantitative methods from prevailing in practical environment.

The cross sectional area (CSA) of spinal canal with varying cut-off levels may be applied quantitative criterion for central stenosis. Nevertheless, currently the region requires human interpretation to define the area manually for the quantitative analysis. Normally, experienced radiologists or clinicians circled the CSA on the lumbar axial T2 weighted magnetic resonance images (MRI) since cerebrospinal fluid has higher contrast in T2 weighted image. Unfortunately, the manual process requires a lot of time and effort, and may inevitably result in errors.

In clinical practice, the extent of LSS is referred to as the cross-section area (CSA) of the spinal canal. This area is usually evaluated on the lumbar axial T2-weighted magnetic resonance images (MRI) since cerebrospinal fluid is relatively easier to be observed in T2-weighted image. The size of CSA is closely related to clinical neurological symptoms, so measurement of CSA of the spinal canal is important in diagnosis of LSS. Due to the irregular shape of the CSA of the spinal canal, the CSA can only be manually defined by experienced experts, for example, doctors, from T2-weighted images, and the size of CSA is determined by calculating pixels of the CSA image via software. However, tolerance of the manually drafted or illustrated CSA may result in misdiagnosis of the size of the CSA of the spinal canal.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a method of determining the training region of cerebrospinal fluid area of spinal canal in accordance with some embodiments of the present disclosure.

FIG. 1A illustrates a method of determining size of cerebrospinal fluid area of spinal canal in accordance with some embodiments of the present disclosure.

FIG. 2 illustrates an operation of determination of a training region in accordance with some embodiments of the present disclosure.

FIG. 2A illustrates a selected training slice in accordance with some embodiments of the present disclosure.

FIG. 2B illustrates a selected training slice in accordance with some embodiments of the present disclosure.

FIG. 3 illustrates an operation of sampling pixels of the first target area/training region in accordance with some embodiments of the present disclosure.

FIG. 4 illustrates a distribution of CSF pixels and background pixels in accordance with some embodiments of the present disclosure.

FIG. 5 illustrates a result of operation 13 in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It would be desired to have a method to precisely determine size of a cerebrospinal fluid area of spinal canal.

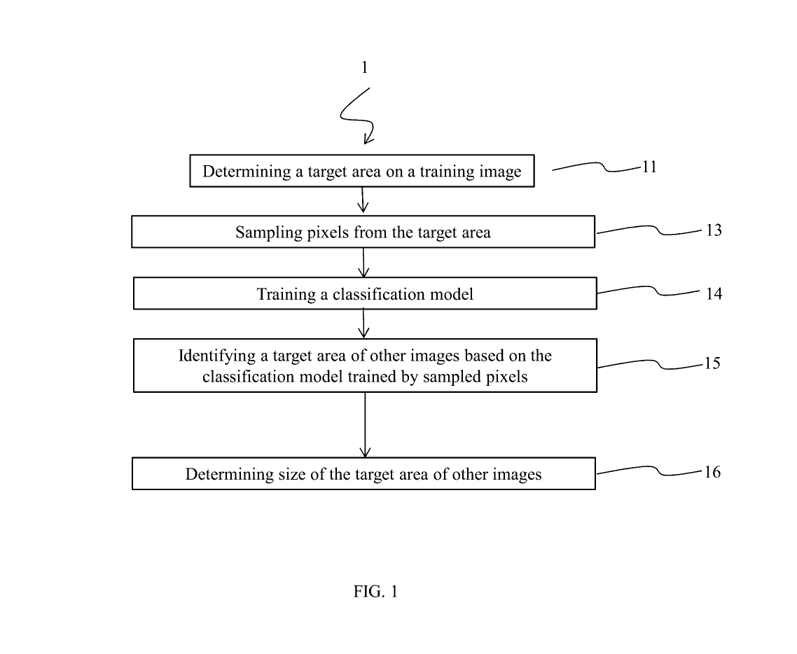

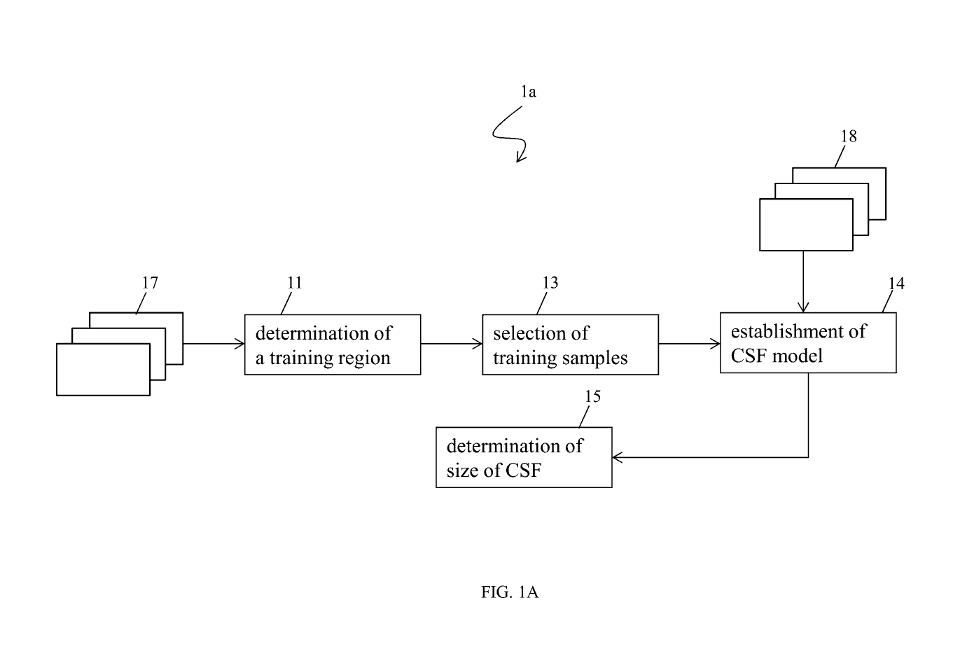

FIG. 1 illustrates a method of determining size of a cerebrospinal fluid area of spinal canal in accordance with some embodiments of the present disclosure.

Referring to FIG. 1, the method 1 of determining size of a cerebrospinal fluid area of spinal canal may include the following operations: in operation 11, a target area of a training image is determined; training pixels from the target area are sampling in operation 13; in operation 14, the sampled pixels are used to train a classification model; Operation 15 identifies the target area of other images based on the classification trained by sampled pixels. Size of the target areas in other images is calculated in operation 16.

FIG. 1A illustrates a method of determining size of cerebrospinal fluid area of spinal canal in accordance with some embodiments of the present disclosure. Referring to FIG. 1A, the method 1a is similar to the method 1 as described and illustrated with reference to FIG. 1, except that magnetic resonance (MR) images 17 and 18 are included in the method 1a for explanation.

MR images 17 of a human body, for example but is not limited to, MR images of lumbar region of spine, are provided. The MR images 17 may be acquired by, for example but is not limited to GE Healthcare—1.5T MR technology. Axial, 2D images 16 are acquired with 512*512 acquisition matrix. The MR images 17 of lumbar region of spine include a number of slices. Each the MR images 17 may include but is not limited to about 17 separate slices. The MR images 17 may include T1-weighted MR image slices and T2-weighted MR image slices. Each axial spine slice includes two feature images: T1-weighted, T2-weighted. T1-weighted images are acquired using standard spin echo (SE) sequence. While T2-weighted images are collected using Turbo Spin Echo (TSE) sequences. Each of the T1-weighted MR image slices and T2-weighted MR image slices shows the cross-section area (CSA) of spinal canal. The CSA of spinal canal includes cerebrospinal fluid (CSF) and non-CSF material, such as spinal nerve roots, etc.

One of the slices of the MR image 18, for example, the slice showing most CSF contained in the CSA, may be selected as a training sliceimage.

In operation 11, a training regiontarget area of the selected training sliceimage is determined. The training regiontarget area may be a CSA region of spinal canal.

Once the training regiontarget area of the training sliceimage is determined in operation 11, pixels of the training regiontarget area are sampled or selected in operation 13.

The sampled or selected pixels may be used to establish a CSF model to identify a target area of other images in operation 14. Other images may be elected from other MR images 18, which may be the same or other slices of the MR images 17. The target area is a CSF region of spinal canal.

The classified CSF regions are then used to determine the size of other target area of the second image 18.

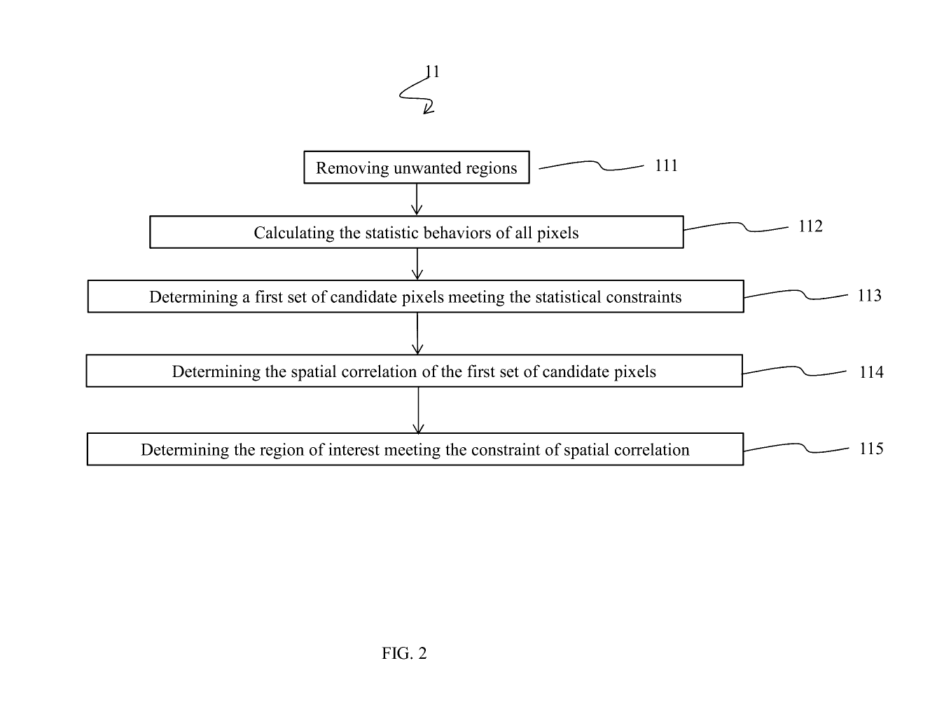

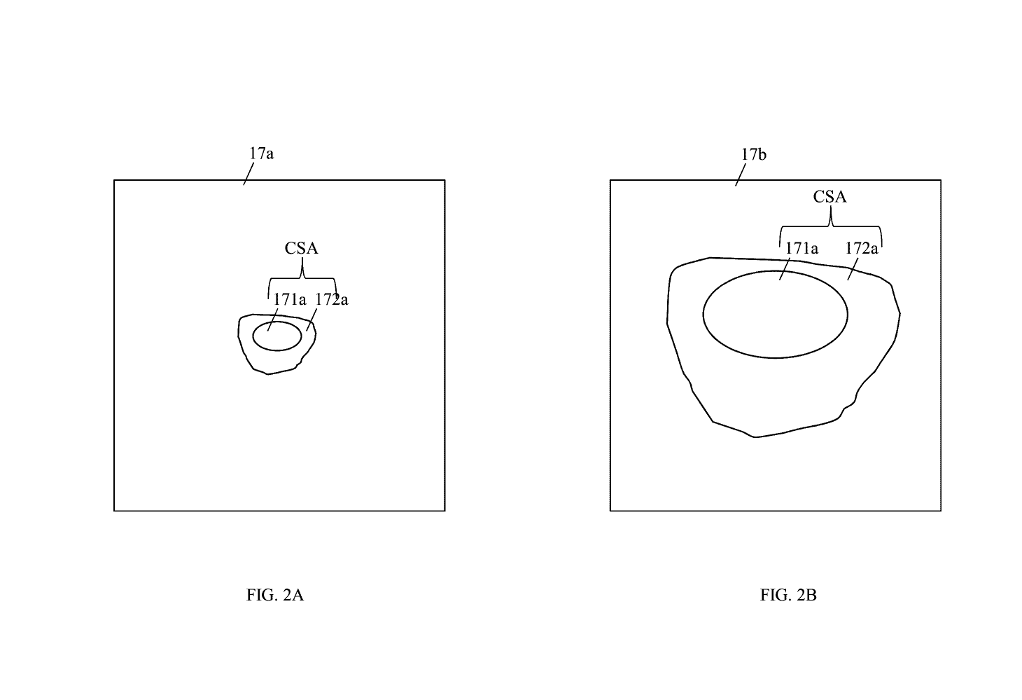

FIG. 2 illustrates an operation of determination of a training region in accordance with some embodiments of the present disclosure.

Referring to FIG. 2, the operation 11 may include operations 111, 112, 113, 114, and 115.

Operation 111 remove the unwanted regions, which are the ones without any region of interest.

FIG. 2A illustrates a selected training slice in accordance with some embodiments of the present disclosure. Referring to FIG. 2A, a training slice 17a is selected from the MR images 17 as shown in FIG. 1A. The selected training slice 17a includes a CSA region of spinal canal, which includes a CSF region 171a and a non-CSF region 172.

In operation 111, unwanted regions, for example, the non-CSA region which contains no CSA of spinal canal, are removed. Since the CSA region of spinal canal generally locates in the central part of MR image 17a, the central part of MR image 17a is selected as a target part. For example, if the MR image 17a has a size of 512 pixels×512 pixels, one-third (⅓) of the MR image 17a from the central part would be selected as a target part and the other regions other than the CSA region are removed.

FIG. 2B illustrates a selected training slice in accordance with some embodiments of the present disclosure. Referring to FIG. 2B, the MR image 17b is a result of the operation 111 performed on the MR image 17a, where only the central part of MR image 17a, e.g. the CSA region of spinal canal is kept or determined as a target part.

Referring back to FIG. 2, in operation 112, the statistical behaviors of all pixels are calculated based on pixel values in T1 and T2-weighted images and difference between them. Operation 112 may be performed by assuming that rᵢ^{T1} and rᵢ^{T2} are pixel values in T1 and T2-weighted images, where i=1, 2, . . . , N, while N is an positive integer to indicate the number of pixels. The statistical lower outer fence in T1-weighted image is represented as r^{T1-outlier}, and the statistical upper outer fense in T2-weighted images may be calculated as r^{T2-outlier}. A difference between them rᵢ^{d} is obtained by subtracting T2-weighted images from T1 in equation I: rᵢ^{d}=|r₁^{T1}−rᵢ^{T2}|. The statistical upper outer fence, the upper quartile plus three times of the interquartile range, may be indicated as r^{d-outlier}.

Operation 113 determines a first set of pixels which meet the statistical constraints. The statistical upper outer fence is considered as a threshold to generate the first set of pixel. For example, pixels is determined as the first set of CSF candidates if its value in T2-weighted image is larger than the upper outer fence but less than lower outer fence in T1-weighted image. Besides, the difference between T1 and T2-weighted image is larger than the upper outer fence. The pixels with the indicator Iᵢ^{first}=1 are selected into the first set of candidates. The indicator Iᵢ^{first} is determined by the equation II.

$${I}_{i}^{first} = \{ \begin{matrix}1 , if \{ {r}_{i}^{d} \geq {r}^{d - outlier} ⋂ {r}_{i}^{T 2} \geq {r}^{T 2 - outlier} ⋂ {r}_{i}^{T 1} < {r}^{T 1 - outlier} \} \\ 0 , others\end{matrix}$$

Spatial correlation of the first set of pixels may be determined as the features in operation 114. For example, the connected components of the first set of pixels are labeled, and the size of labeled areas are calculated.

Operations 115 determines the region of interest based on the spatial correlation of labeled area. For example, the labeled region with the maximum size may be considered as the target region of the training slice/image.

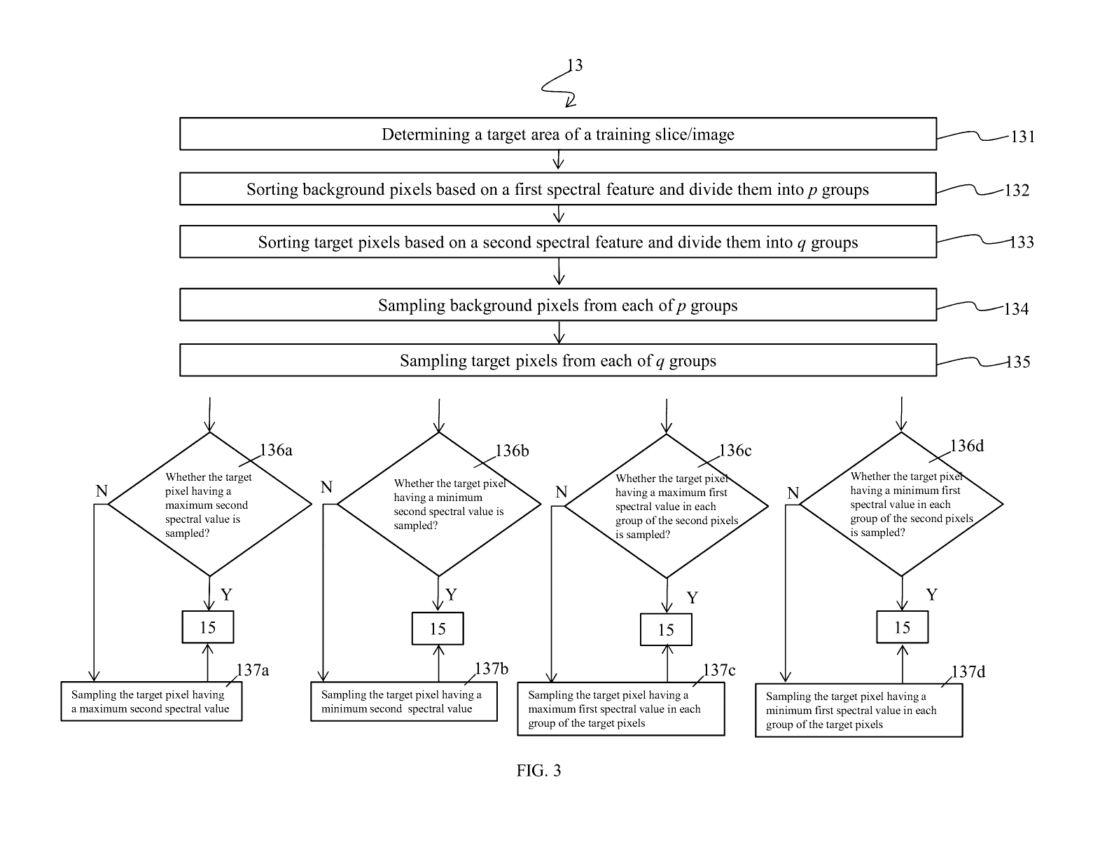

FIG. 3 illustrates an operation of sampling pixels of the target area on the training slice/image in accordance with some embodiments of the present disclosure.

Referring to FIG. 3, the operation 13 may include operations 131, 132, 133, 134 and 135.

In operation 131, CSF pixels and non-CSF/background pixels are determined based on statistical and spatial features of pixels in the training slice/image as determined in operation 11. CSF pixels and non-CSF/background pixels may be distributed in accordance with T1 value and T2 value of each pixel.

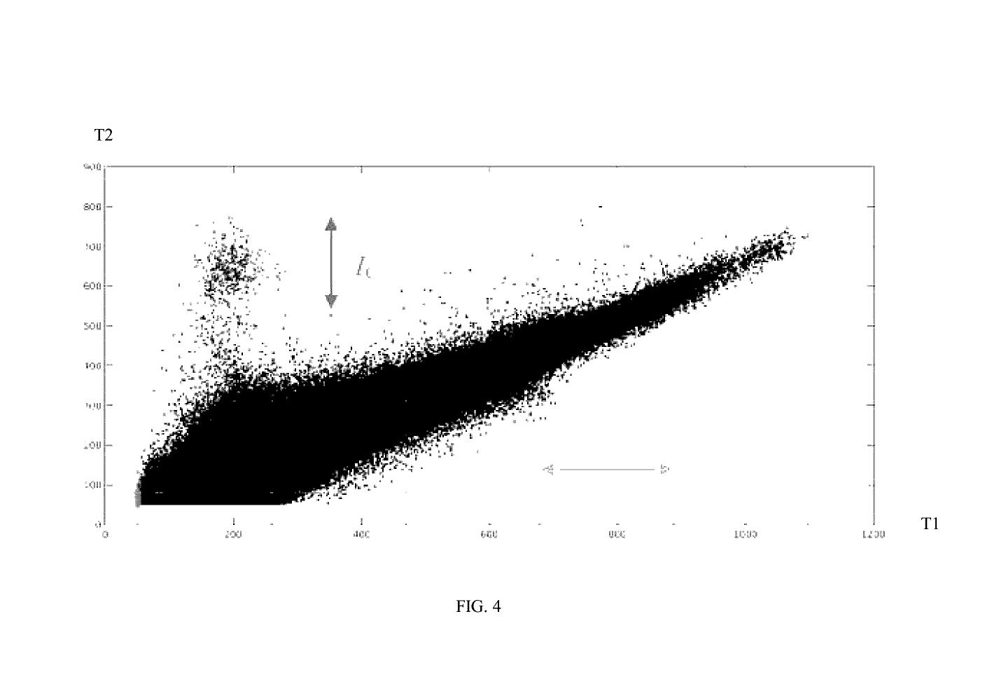

FIG. 4 illustrates a distribution of CSF pixels and background pixels in accordance with some embodiments of the present disclosure. Referring to FIG. 4, each of CSF pixels (shown by red dots) and background pixels (shown by blue dots) is distributed in accordance with respective T1 value and T2 value thereof.

Referring back to FIG. 3, in operation 132, non-CSF/background pixels with minimum T1 value and maximum T1 value are denoted as B_{T1}^{min} and B_{T1}^{max}. The region in which the non-CSF/background pixels are distributed is divided into “p” sub-regions and each has an interval I_{B} in T1, which is defined by equation III:

$${I}_{B} = \frac{{B}^{{T}_{i}^{ma x}} - {B}^{{T}_{1}^{m i n}}}{p} ,$$

where p is a positive integer. Accordingly, the background pixels are sorted or divided into p groups based on a first spectral feature (e.g. “T1” value).

In operation 133, CSF pixels with minimum T2 value and maximum T2 value are denoted as C_{T2}^{miN} and C_{T2}^{max}. The region in which the CSF pixels are distributed is divided into “q” sub-regions each has an interval I_{C} in T2 defined by equation VI:

$${I}_{C} = \frac{{C}^{{T}_{2}^{ma x}} - {C}^{{T}_{2}^{m i n}}}{q} ,$$

where q is a positive integer. Accordingly, the CSF pixels are sorted or divided into q groups based on a second spectral feature (e.g. “T2” value).

In operation 134, a predetermined number of background pixels, for example “r” background pixels, may be required, while r is a positive integer. The “r” background pixels are sampled or picked from each of p groups of the background pixels. Accordingly, a number of r/p background pixels may be sampled or picked from each of the “p” sub-regions.

In operation 135, a predetermined number of CSF pixels, for example “r” CSF pixels, may be required, while r is a positive integer. The “r” CSF pixels are sampled or picked from each of q groups of the CSF pixels. Accordingly, a number of r/q CSF pixels may be sampled or picked from each of the “q” sub-regions.

The operation 13 may further include operations 136a, 136b, 136c, 136d, 137a, 137b, 137c and 137d.

In operation 136a, the r/q CSF pixels sampled or picked in operation 135 are checked or determined to see whether the r/q CSF pixels include a CSF pixel (e.g. C_{T2}^{max}) having a maximum T2 value. If the r/q CSF pixels include a CSF pixel having a maximum T2 value, the operation goes to operation 15 as shown in FIG. 1. If the r/q CSF pixels do not include a CSF pixel having a maximum T2 value, the CSF pixel having a maximum T2 value is sampled or picked in operation 137a.

In operation 136b, the r/q CSF pixels sampled or picked in operation 135 are checked or determined to see whether the r/q CSF pixels include a CSF pixel (e.g. C_{T2}^{min}) having a minimum T2 value. If the r/q CSF pixels include a CSF pixel having a minimum T2 value, the operation goes to operation 15 as shown in FIG. 1. If the r/q CSF pixels do not include a CSF pixel having a minimum T2 value, the CSF pixel having a minimum T2 value is sampled or picked in operation 137b.

In operation 136c, the r/q CSF pixels sampled or picked in operation 135 are checked or determined to see whether the r/q CSF pixels include a CSF pixel (e.g. Cᵢ^{T1max}) having a maximum T1 value in each of the “p” sub-regions, while j=1, 2, . . . , p. If the r/q CSF pixels include a CSF pixel having a maximum T1 value in each of the “p” sub-regions, the operation goes to operation 15 as shown in FIG. 1. If the r/q CSF pixels do not include a CSF pixel having a maximum T1 value in each of the “p” sub-regions, the CSF pixel having a maximum T1 value in each of the “p” sub-regions is sampled or picked in operation 137c.

In operation 136d, the r/q CSF pixels sampled or picked in operation 135 are checked or determined to see whether the r/q CSF pixels include a CSF pixel (e.g. Cᵢ^{T1min}) having a minimum T1 value in each of the “p” sub-regions, while j=1, 2, . . . , p. If the r/q CSF pixels include a CSF pixel having a minimum T1 value in each of the “p” sub-regions, the operation goes to operation 15 as shown in FIG. 1. If the r/q CSF pixels do not include a CSF pixel having a minimum T1 value in each of the “p” sub-regions, the CSF pixel having a minimum T1 value in each of the “p” sub-regions is sampled or picked in operation 137d.

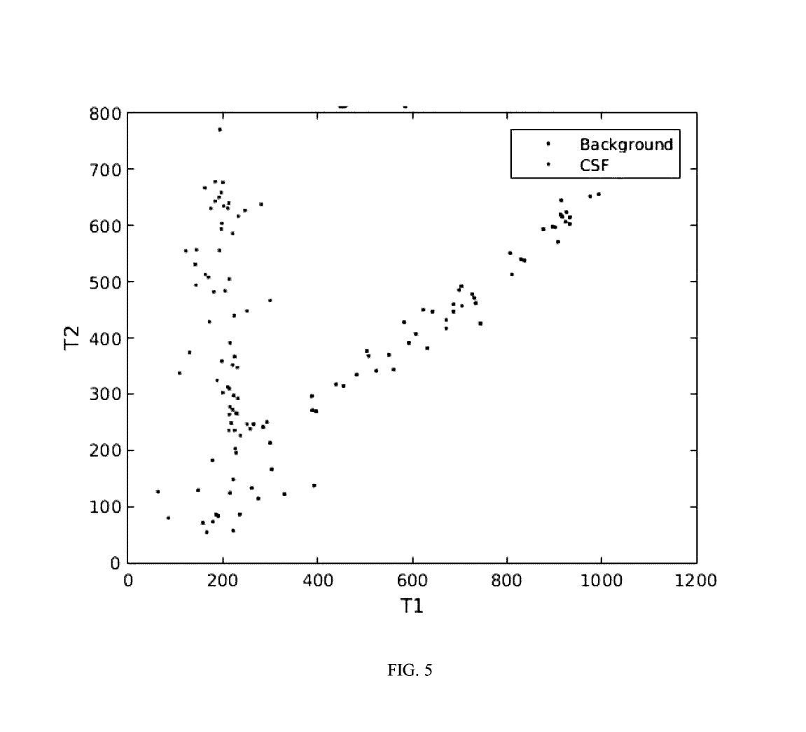

FIG. 5 illustrates a result of operation 13 in accordance with some embodiments of the present disclosure. Referring to FIG. 5, the sampled background pixels and CSF pixels are illustrated.

Referring back to FIG. 1A, the sampled background pixels and CSF pixels as shown in FIG. 5 may be used to establish a CSF model in operation 14. In operation 14, the sampled background pixels and CSF pixels as shown in FIG. 5 are provided to, for example but is not limited to a support vector machine (SVM) to establish a CSF model. The CSF model can identify the target area of other slices/images in operation 14. Other images may be selected from the MR images 18, which may be the same or similar to the MR images 17. The target area is a CSF region of spinal canal.

In machine learning, support vector machines are supervised learning models with associated learning algorithms that analyze data and recognize patterns, used for classification and regression analysis. Given a set of training examples, each marked for belonging to one of two categories, an SVM training algorithm builds a model that assigns new examples into one category or the other, making it a non-probabilistic binary linear classifier. An SVM model is a representation of the examples as points in space, mapped so that the examples of the separate categories are divided by a clear gap that is as wide as possible. New examples are then mapped into that same space and predicted to belong to a category based on which side of the gap they fall on. In addition to performing linear classification, SVMs can efficiently perform a non-linear classification using what is called the kernel trick, implicitly mapping their inputs into high-dimensional feature spaces.

Once the target area (e.g. CSF region of spinal canal) of other slices/images (e.g. an image be selected from the MR images 18, which may be the same or similar to the MR images 17) is identified by the CSF model in operation 14, the size of the CSF region of spinal canal can be determined in operation 15.

In accordance with some embodiments of the present disclosure, a method of sampling pixels of an image includes: determining a target area of the image; and sampling pixels of the target area. Sampling pixels of the target area includes: determining background pixels based on a first spectral feature of pixels; determining target pixels based on a second spectral features of pixels; sorting the first pixels into a number of groups based on the first spectral feature; sorting the second pixels into a number of groups based on the second spectral feature; sampling the background pixels from each of groups; and sampling the target pixels from each of groups.

In accordance with some embodiments of the present disclosure, a method of determining the target region of training slice/image includes: removing the unwanted regions; calculating the statistic behaviors of all pixels; determining a first set of candidate pixels meeting the statistical constraints; determining the spatial correlation of the first set of pixels; determining the region of interest meeting the constraint of spatial correlation.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of sampling pixels of an image, comprising:
determining a target area on the image; and
sampling pixels from the target area, comprising:
sorting background pixels based on a first spectral feature and divide them into a first number of groups;
sorting target pixels based on a second spectral feature and divide them into a second number of groups;
sampling background pixels from each of the first number of groups; and
sampling target pixels from each of the second number of groups.

2. The method of claim 1, further comprising determining whether a target pixel having a maximum second spectral value is sampled.

3. The method of claim 2, further comprising sampling the target pixel having a maximum second spectral value if the target pixel having a maximum second spectral value is not sampled.

4. The method of claim 1, further comprising determining whether a target pixel having a minimum second spectral value is sampled.

5. The method of claim 4, further comprising sampling the target pixel having a minimum second spectral value if the target pixel having a maximum second spectral value is not sampled.

6. The method of claim 1, further comprising determining whether a target pixel having a maximum first spectral value in each group of the target pixels is sampled.

7. The method of claim 6, further comprising sampling the target pixel having a maximum first spectral value in each group of the target pixels if the target pixel having a maximum first spectral value in each group of the target pixels is not sampled.

8. The method of claim 1, further comprising determining whether a target pixel having a minimum first spectral value in each group of the target pixels is sampled.

9. The method of claim 8, further comprising sampling the target pixel having a minimum first spectral value in each group of the target pixels if the target pixel having a minimum first spectral value in each group of the target pixels is not sampled.

10. A method of determining a target area of an image, comprising:
determining the target area on the image;
sampling pixels from the target area, comprising:
sorting background pixels based on a first spectral feature and divide them into a first number of groups;
sorting target pixels based on a second spectral feature and divide them into a second number of groups;
sampling background pixels from each of the first number of groups; and
sampling target pixels from each of the second number of groups;
training a classification model;
identifying a target area of other images based on the classification model; and
determining size of the target area of other images.

11. The method of claim 10, further comprising sampling a target pixel having a maximum second spectral value.

12. The method of claim 10, further sampling a target pixel having a minimum second spectral value.

13. The method of claim 10, further comprising sampling a target pixel having a maximum first spectral value in each group of the target pixels.

14. The method of claim 10, further comprising sampling a target pixel having a minimum first spectral value in each group of the target pixels (FIG. 3: 137d).

15. The method of claim 10, wherein determining the target area on the image comprising determining a first set of candidate pixels meeting the statistical constraints.

16. The method of claim 15, further comprising determining the target area meeting the constraint of spatial correlation.
